(19) United States
(12) Patent Application Publication
(10) Pub. No.: US 2002/0042148 A1
(43) Pub. Date: Apr. 11, 2002

(54) Flow cytometer safety cabinet

(76) Inventor: Simon Monard, Upper Jay, NY (US)

Correspondence Address: BAKER & BOTTS, 30 ROCKEFELLER PLAZA, NEW YORK, NY, 10112

(21) Appl. No.: 09/853,154

(22) Filed: May 10, 2001

Related U.S. Application Data
(60) Provisional application No. 60/202,533, filed on May 10, 2000.

(51) Int. Cl. B01L 9/00

(52) U.S. Cl. 436/183; 422/104

(57) ABSTRACT

The present invention relates to a method and apparatus for controlling the escape of aerosols generated from the operation of a flow cytometer. Such aerosols may contain, for example, infectious agents that may pose a safety risk to the operator of the flow cytometer. The apparatus of the invention comprises a biological safety cabinet coupled with a means for producing air flow and filtration. The apparatus of the invention is designed to fit onto the face of a flow cytometer, thereby preventing the escape of aerosols.

### INTRODUCTION

The present invention relates to a method and apparatus for controlling the escape of aerosols generated from the operation of a flow cytometer. Such aerosols may contain, for example, infectious agents that may pose a safety risk to the operator of the flow cytometer. The apparatus of the invention, herein referred to as a flow cytometer safety cabinet comprises a modified biological safety cabinet coupled with a means for producing air flow and air filtration. The apparatus of the invention is designed to fit over the face of a flow cytometer, thereby preventing the escape of aerosols.

### BACKGROUND OF THE INVENTION

Flow cytometry has become a key technology for the study of biological cells. Thus, flow cytometers can be found in many universities, research centers and pharmaceutical companies. The type of flow cytometers known as cell sorters physically separate cells based on their fluorescent and light scattering properties. The process of this separation usually involves the generation of microdroplets containing cells that are deflected with electrical charges into collection tubes. Often, studies will involve biological cells infected with infectious agents. If the cells are infected with infectious agents this method of separation poses a risk of exposure to these agents for the instrument operator and others in the laboratory.

The present invention provides a novel apparatus that can be attached to a flow cytometer to prevent escape of hazardous aerosols from the flow cytometer thereby limiting exposure of the operator to such aerosols. The apparatus of the invention comprises an enclosure and a blower/filter unit which provides a means for producing airflow and air filtration. The device is designed to over the face of the flow cytometer. This is the first description of a biological safety cabinet coupled to a blower/filter unit that addresses the very real problem of hazardous aerosols generated by these instruments.

### SUMMARY OF THE INVENTION

The present invention relates to a method and apparatus for controlling the escape of aerosols generated from the normal operation of a flow cytometer. The apparatus of the invention comprises a modified biological safety cabinet coupled to a blower/filter unit that provides airflow and air filtration. The apparatus of the invention is designed to fit onto the face of a flow cytometer thereby preventing exposure of the flow cytometer operator to hazardous aerosols. The apparatus provides a safe work area for the operator of the flow cytometer to handle and dispose of hazardous or infectious samples. In addition, the apparatus provides safety for the operator from accidental spills or rupture of samples.

The invention further relates to a method for preventing the escape of aerosols generated from the operation of a flow cytometer. The method of the invention comprises providing airflow and air filtration in an enclosure attached to the face of a flow cytometer whereby the airflow prevents the escape of aerosols released from the operation of a flow cytometer and the filter removes any hazardous materials, such as infectious agents, from the air within the enclosure.

Other embodiments of the present invention will become apparent from the following detailed description of the invention when considered in conjunction with the accompanying drawings. Before exploring the embodiments of the invention in detail, it is to be understood that the invention is not limited in its application to the details of the construction and to the arrangement of components as set forth in the following description, or illustrated in the accompanying drawings. The invention is capable of other embodiments and of being practiced and carried out in various ways. Furthermore, it is to be understood that terminology used herein is for the purpose of description and should not be regarded as limiting.

### BRIEF DESCRIPTION OF FIGURES

FIG. 1. Shows the frame of an enclosure 1-11 and the type of extrusion 13 used. The lexan sheet slides into the extrusion frame and the corners are connected with plastic connectors as shown.

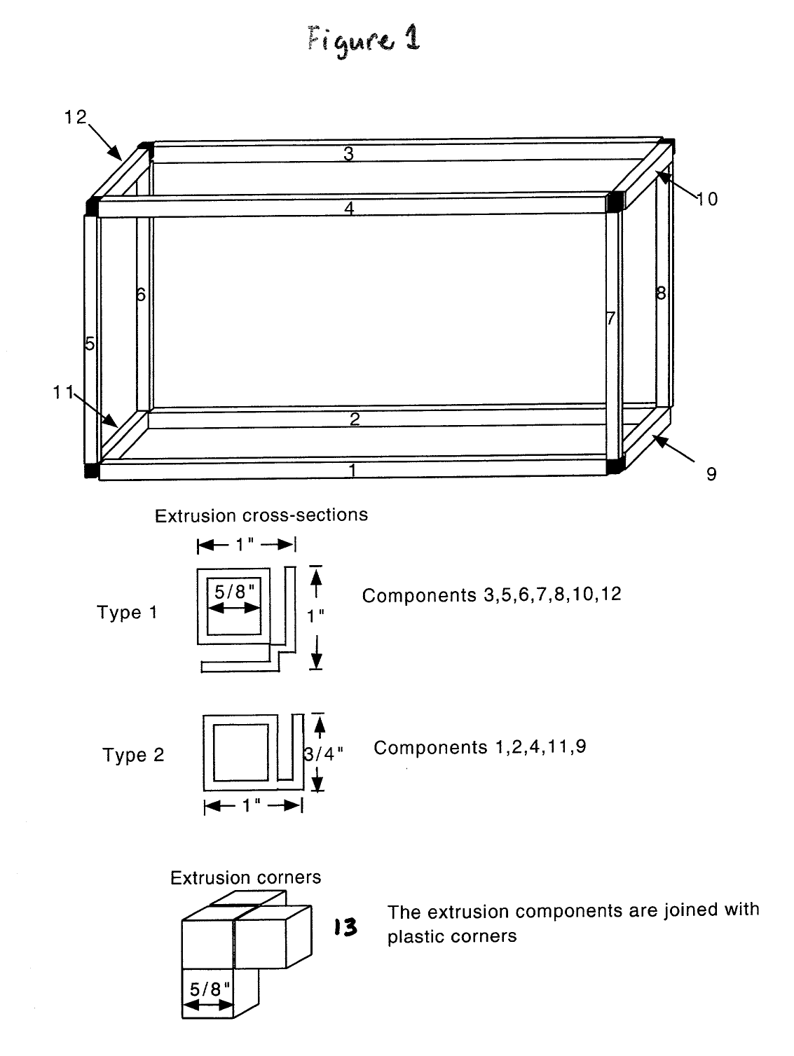

FIG. 2. Shows the size of the enclosure; the most critical dimension being the inside width of the enclosure as this must fit over the face of the instrument. The enclosure bottom 14 is shown.

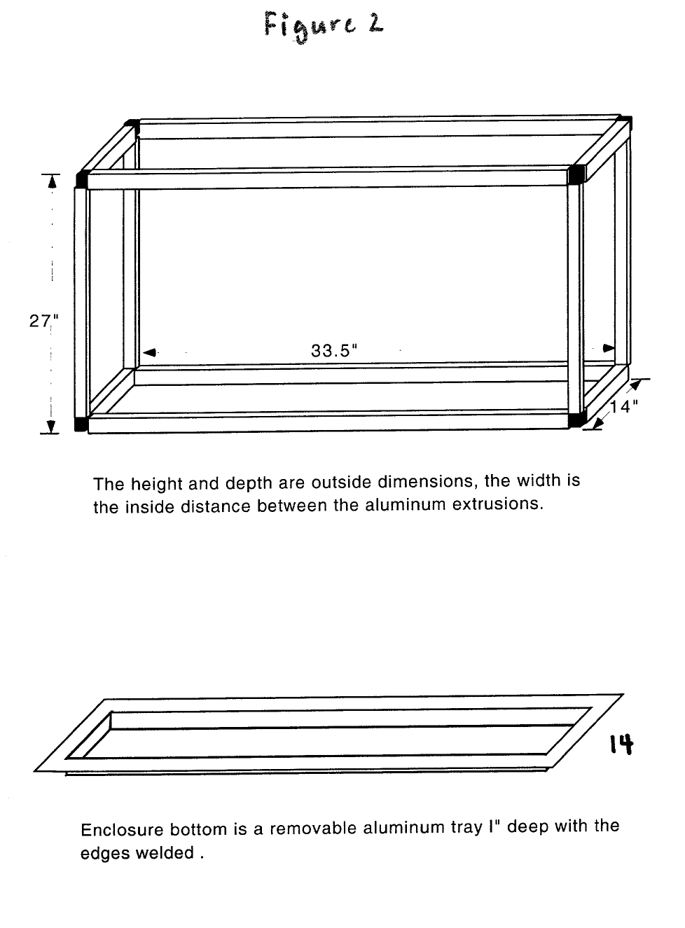

FIG. 3. Shows the door 15 of the enclosure. The lower edge is fitted with type 2 extrusion 17 and the upper edge has a length of aluminum angle 16 to add some rigidity. The door slides in the grooves of the front vertical components of the frame. There are two spring-loaded bolts in the extrusion on the lower edge of the door, which locate into holes drilled into the two front vertical components of the frame. These holes are spaced every two inches allowing the door to be set at various heights. Two small levers operate the bolts.

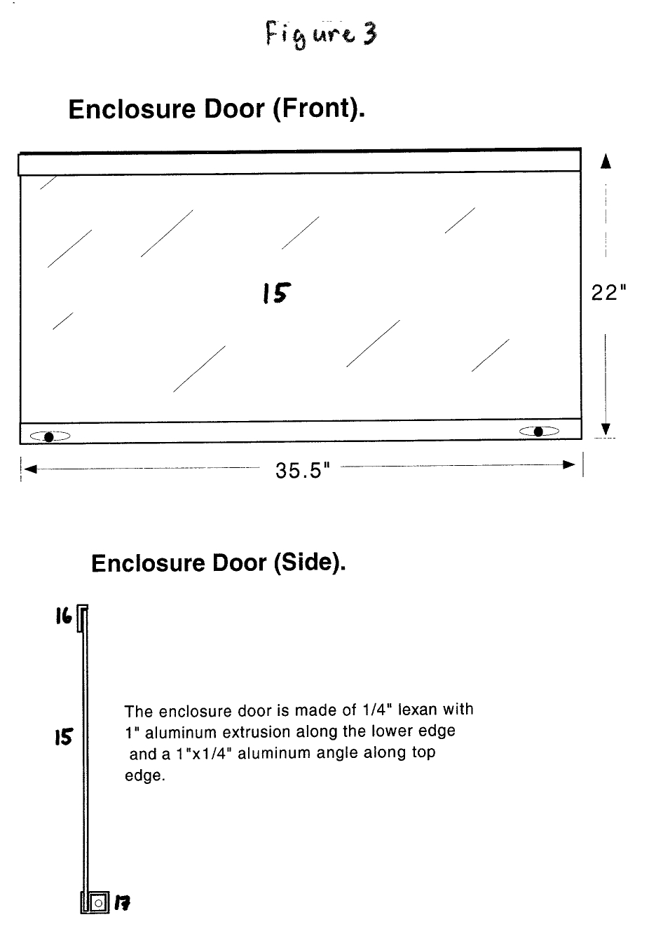

FIG. 4. Shows the front lower panel 18, it is 5 inches high and is not moveable. It has an aluminum molding 19 over it to cover the sharp edge of the lexan.

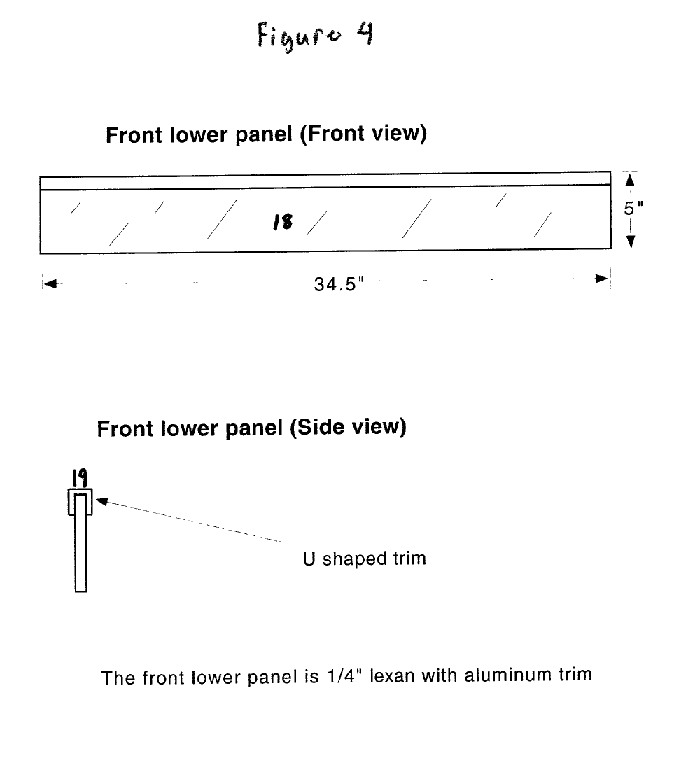

FIG. 5. The sides 20 are simply rectangles of lexan, which fit into the frame.

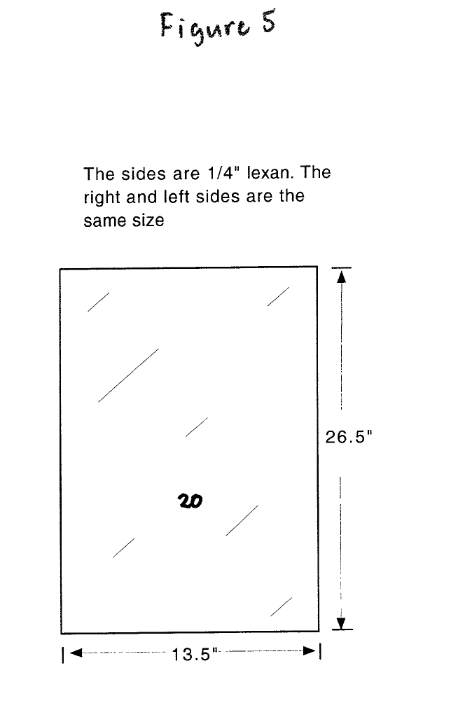

FIG. 6. The top of the enclosure 21 is made of lexan and has two flanges 22 fashioned out of lexan to allow 5″ ducts from the filter/blower unit to be connected to the enclosure. The flanges are positioned nearer to the back of the enclosure.

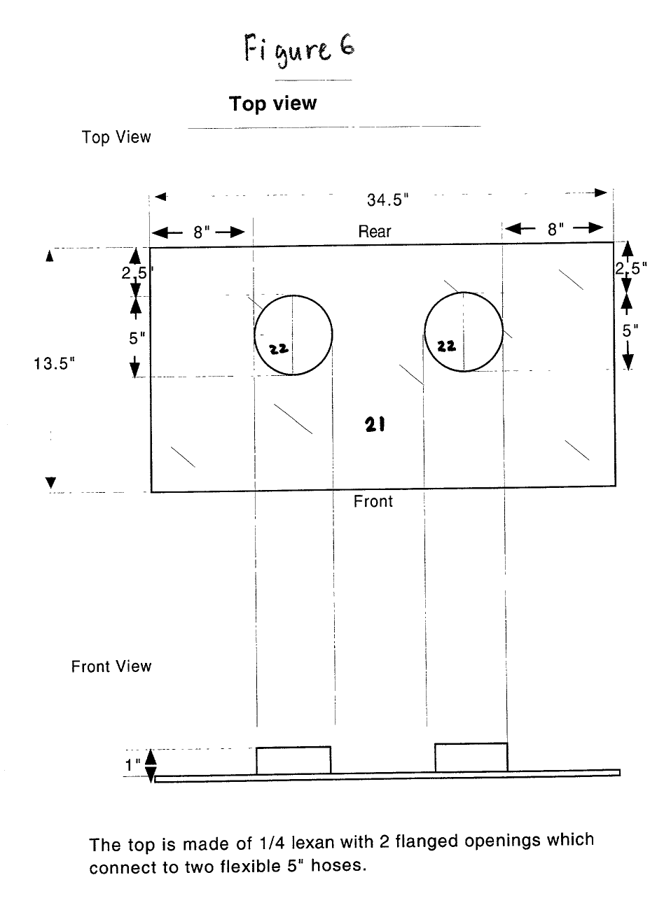

FIG. 7. The back of the enclosure 23 is open except for a 3.5″ strip of lexan at the top and another along the bottom. The lower strip is shaped to fit under the front of the instrument.

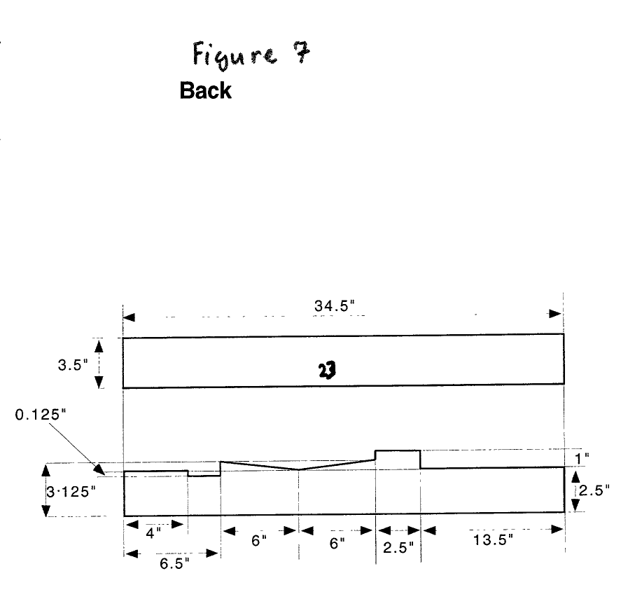

FIG. 8. Depiction of Flow Cytometer Safety Cabinet.

### DETAILED DESCRIPTION OF THE INVENTION

The present invention relates to an apparatus and method for controlling the escape of hazardous aerosols generated from the operation of a flow cytometer. The apparatus of the invention comprises an enclosure coupled with a means for air filtration and for generating an airflow across the opening of the enclosure. The apparatus is designed to fit onto the face of the flow cytometer.

The enclosure of the invention comprises a cabinet designed to fit over the face of a flow cytometer. In an embodiment of the invention, the enclosure comprises a modified biological safety cabinet such as a Class I biosafety cabinet. The exact dimensions of the enclosure will depend on the dimensions of the flow cytometer. Flow cytometers that may be used in conjunction with the apparatus of the invention include but are not limited to the FACStar Plus and FACS Vantage flow cytometers manufactured by Becton Dickinson Corp (Palo Alto, Calif.). However, similar enclosures can be made for any other type of flow cytometer.

The enclosure can be composed of any type of rigid material including, for example, stainless steel or plastics such as transparent polycarbonate. The enclosure may be assembled from individual components, such as those depicted in the figures, or fashioned from a single piece of material, such as plastic. The back of the enclosure is open to fit over the face of the flow cytometer. In addition, the floor of the enclosure may be designed to be removable. For example, the floor may comprise an aluminum tray or stainless steel tray. Further, the front of the unit comprises an adjustable door which when fully open allows the operator to service and align the flow cytometer.

The apparatus of the invention is designed to fit over the face of the flow cytometer. Attachment of the enclosure to the face of the flow cytometer can be by any means, including but not limited to the use of bolts, clamps, latches, screws or magnets. In addition, silicon sealants or adhesive materials such as closed cell foams may be used to form a seal between the enclosure and the instrument.

In addition to the enclosure, the apparatus of the invention comprises a means for producing an air flow across the front opening of the enclosure so as to prevent the escape of aerosols and to provided for air filtration (herein referred to as blower/filter unit). Such air flow is produced by providing negative air pressure within the enclosure. Such blower/filter units include, for example, those commercially available from AirFiltronics (Clifton, N.J.) and Flow Sciences (Wilmington, Del.). Filters to be used for filtration of the air include, for example, HEPA filters. In a non-limiting embodiment of the invention, the enclosure may be attached to the blower/filter unit directly. Alternatively, the blower/filter unit may be attached to the enclosure with flexible ducting. Further, the filter/blower unit can be positioned on the floor or on a shelf above the flow cytometer.

When operating the flow cytometer the front door of the enclosure will be open to allow operation of the flow cytometer. Alternatively, the door may be closed, however, in such instances the air flow should be adjusted to maintain air flow through any remaining openings in the enclosure. The air velocity should be tested with a handheld anemometer though the opening and the blower adjusted to produce a face velocity of 120 feet per minute (fpm). An airflow alarm can be attached inside the hood near the opening and set to sound when the airflow is less than 100 fpm.

Before operating with infective samples the integrity of the apparatus should be tested by setting up the flow cytometer to do a sort, then testing as previously described (Merrill J T. Cytometry 1:342-345; Sorensen et al. Cytometry 37:284-290). Briefly, agar containing petri dishes are positioned all around the hood, bench, blower unit and within the hood itself. A suspension of high titer bacteriophage is then passed through the instrument. To mimic the effects of a clog, the sample is boosted through the instrument at high pressure, the sample probe should be intermittently raised above the sample in the tube causing massive aerosolization of the sample. After the sample has been removed from the instrument the petri dishes are left in position for 2 hours. They are then layered with a lawn of E. coli and incubated for 24 hours. A single bacteriophage particle will cause a plaque on the E. coli lawn. No plaques should be seen on the petri dishes outside of the enclosure.

Once the hood has been found to be effective, a certified Biological Safety Cabinet engineer can be called to certify the hood. The engineer can test various aspects of the hood and give specifications of the performance. If these specifications are unchanged when the hood is tested at a later date it is reasonable to assume that the hood will perform the same as with the initial bacteriophage testing.

Each time the hood is used to contain infective samples the airflow through the opening should be tested with a handheld anemometer. The same good laboratory practice (GLP) should be used as when working in any other biological safety cabinets. After the sort is completed, the blower unit should be left on for an hour with the sort chamber door in the open position. The instrument and inside of the hood should then be decontaminated with 10% bleach.

### EXAMPLE

Construction of a Flow Cytometer Safety Cabinet

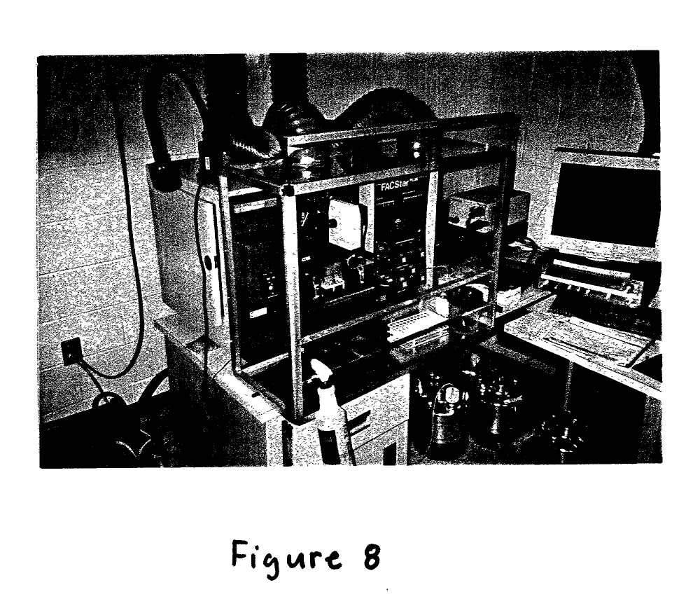

The following example describe the construction of a flow cytometer safety cabinet as depicted in FIG. 8. The apparatus of the invention is constructed in two parts, the enclosure and the filter/blower unit. The filter blower unit was purchased from Airfiltronics Inc. The enclosure was designed to fit over the face of a FACStar Plus flow cytometer maunfactured by Becton Dickenson (Palo Alto, Calif.). The enclosure was made of ¼ inch transparent polycarbonate (lexan) with 1 inch aluminum frame. The lexan parts are designed to slide into a goove in the aluminum frame. The back of the unit is open to fit onto the face of the flow cytometer. The floor of the unit was constructed as a removable aluminum tray. The front of the unit comprises a sliding door which when fully opened allows the operator to service and align the instrument. The top of the unit has two 5 inch diameter lexan flanges, which connect the enclosure to the filter/blower unit.

The enclosure is attached to the flow cytometer with screws through the rear vertical members of the enclosure into the cytometer body. Adhesive 0.5 inch wide closed cell foam was used to seal between the enclosure and the instrument. The enclosure attached to the filter/blower unit with two lengths of 5 inch diameter flexible ducting.

When operated the opening of the enclosure is open approximately 4.5 inches. The air velocity is tested with a hand held anemometer through the opening and the blower is adjusted to produce a face velocity of 120 feet per minute (FPM).

### EXAMPLE

Phage Testing

The following example describes testing of the flow cytometer safety cabinet demonstrating the successful prevention of aerosol escape.

Agar containing petri dishes were positioned all around the hood, bench, blower unit and within the hood itself. A suspension of high titer bacteriophage was then passed through the instrument. Either 2 ml or 4 ml of phage suspension was aspirated. To mimic the effects of a clog, the sample was boosted through the instrument at high pressure, the sample probe was intermittently raised above the sample in the tube causing massive aerosolization of the sample in the sort chamber. The drop drive was repeatedly turned off and on with the high voltage plates on which also creates a spray from the nozzle. The sort chamber door was also repeatedly opened and closed. After the sample had been removed from the instrument the petri dishes were left in position for 2 hours. The dishes were then layered with a lawn of E. coli and incubated for 24 hours. A single bacteriophage particle will cause a plaque on the E. coli lawn.

### Experiment #1

The experiment was conducted using a FACStar Plus flow cytometer. The running conditions were set for 11 psi sheath pressure and a face velocity of 110 fpm when utilizing a biosafety cabinet. The bacteriophage concentration was 10⁹/ml. The petri dishes initially only contained agar.

Sort 1

Biosafety Cabinet on/beads/(−) phage. Five petri dishes were placed within the cabinet, one petri dishe was placed on the ACDU tray onto which 5000 beads were sorted.

Sort 2

Biosafety Cabinet on/beads/(+) phage. Forty petri dishes were placed at various locations both inside the cabinet, including the sort chamber, and outside the cabinet.

Sort 3

Biosafety Cabinet off/beads/(+) phage. Ten petri dishes were placed at various locations both inside the cabinet, including the sort chamber, and outside the cabinet.

All petri dishes were numbered and their positions and the sort conditions noted. All petri dishes were left in position for two hours, the lids were then replaced and they were removed from the flow lab where they were then layered with a lawn of E. coli.

Results:

Sort 1

No plaques

Sort 2

The petri dish on the ACDU arm which had fluid directly added were confluent.

Two petri dishes placed within the sort chamber had 1000 and 50 plaques

One petri dish placed on top of the sort chamber (not in it) had 50 plaques.

All other petri dishes were negative.

Sort 3

Two petri dishes placed within the sort chamber had >1000 and 150 plaques

Two petri dishes placed on the floor of the hood had 2 and 1 plaques

All other plates were negative.

The results demonstrate that the hood was capable of containing all. If the hood had not been in place particles would have escaped the sort chamber into the lab

### Experiment #2

The experiment was conducted using a FACS VANTAGE flow cytometer. The running conditions were set for 35 psi sheath pressure. The front opening of the enclosure was open 4.5″, and the face velocity was set to 110 fpm. The air flow through the ACDU arm hole was 70 fpm with the sort chamber door shut and 90 fpm with it open. A 4 ml suspension of bacteriophage at a concentration of 10¹⁰/ml was aspirated. The petri dishes initially only contained agar. 35 petri dishes were placed at various locations within the sort chamber, within the enclosure and outside the enclosure. The petri dishes were left for two hours before the lids were replaced. They were then layered with a lawn of E. coli and incubated overnight.

Results:

Petri dishes placed within the sort chamber had >3000, 1000 and 1 plate was confluent

One petri dish in the sample well had >3000 plaques.

Two petri dishes on the floor of the hood had 67 and 21 plaques.

One petri dish next to the stream positioning controls has 2 plaques.

There were no other plaques.

The present invention is not to be limited in scope by the specific embodiments described herein which are intended as single illustrations of individual aspects of the invention, and functionally equivalent methods and components are within the scope of the invention. Indeed, various modifications of the invention, in addition to those shown and described herein will become apparent to those skilled in the art from the foregoing description and accompanying drawings. Such modifications are intended to fall within the scope of the claims. Various publications are cited herein, the contents of which are hereby incorporated, by reference, in their entireties.

What is claimed:

1. An apparatus for controlling the escape of aerosols generated from the operation of a flow cytometer comprising:
(i) an enclosure defining a work surface in a compartment which is accessible from one side by the operator of the flow cytometer and which is open on one side for placement over the face of a flow cytometer; and
(ii) a means for providing air flow and air filtration within the enclosure.

2. The apparatus of claim 1 wherein the means for providing air flow produces negative pressure within the enclosure.

3. The apparatus of claim 1 wherein the means for providing air flow and air filtration is a filter/blower unit.

5. The apparatus of claim 1 wherein the means for providing air flow and air filtration is coupled directly to the enclosure.

6. The apparatus of claim 1 wherein the means for providing air flow and air filtration is attached with flexible ducting.

7. The apparatus of claim 1 wherein the enclosure is constructed of plastic.

8. The apparatus of claim 7 wherein the enclosure is constructed of transparent polycarbonate.

9. A method for preventing the escape of hazardous aerosols generated from the operation of a flow cytometer comprising, providing airflow and air filtration in an enclosure wherein said enclosure comprises a work surface which is accessible from one side by a operator of the flow cytometer and which is open on one side for placement over the face of a flow cytometer whereby the airflow prevents the escape of aerosols released from the operation of a flow cytometer and the air filtration removes hazardous materials from the air within the enclosure.

10. The method of claim 9 wherein the airflow and air filtration are provided by a blower/filter unit.

11. The method of claim 9 wherein the hazardous material comprises infectious agents.

12. The method of claim 9 wherein the means for providing air flow and air filtration is attached directly to the enclosure.

13. The method of claim 9 wherein the means for providing air flow and air filtration is attached to the enclosure with flexible ducting.
